(19) United States
(12) Patent Application Publication
(10) Pub. No.: US 2013/0179316 A1
(43) Pub. Date: Jul. 11, 2013

(54) Automatic Savings Plan Generation

(71) Applicant: Erik Stephen Ross, Charlotte, NC (US)

(72) Inventor: Erik Stephen Ross, Charlotte, NC (US)

(73) Assignee: BANK OF AMERICA CORPORATION, Charlotte, NC (US)

(21) Appl. No.: 13/346,863

(22) Filed: Jan. 10, 2012

(51) Int. Cl. G06Q 40/00

(52) U.S. Cl. 705/35

(57) ABSTRACT

Aspects of the disclosure relate to a provisioning of a savings plan for one or more users. In some embodiments, a plan may be generated based on an analysis of information associated with a user. The plan may be adapted or modified over time, optionally in response to the occurrence of one or more events. In some embodiments, a user may have an opportunity to modify a term, value, or condition associated with the plan or a portion thereof. In some embodiments, a user may be provided an incentive for participating in the plan. For example, a user may receive a contribution or be enrolled in a lottery.

### TECHNICAL FIELD

Aspects of this disclosure generally relate to providing a user with information. In particular, aspects of this disclosure relate to providing a user with a recommended saving plan based on any number of input factors.

### BACKGROUND

People generally tend to be very busy in terms of the day-to-day lives. For example, people may go to work or school during the day, tend to chores or other tasks as night, and if they are lucky, they may engage in a leisure activity (e.g., watching television) before going to sleep in preparation for the next day. Given how busy people typically are, they may lose sight of the “bigger picture” when it comes to their finances. As a result, people might not be prepared to incur a large expense, particularly if that large expense is unforeseeable. Current strategies and techniques are insufficient for securing one's financial future.

### BRIEF SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the disclosure may address one or more of the issues mentioned above via one or more methods, computer-readable media, systems, and/or apparatuses. In some embodiments, a user may be provided with a plan, such as a savings plan. The plan may be established automatically, in response to manual input, or based on a combination of automated features in conjunction with manual input. In some embodiments, the plan may be based on an outflow or expenditure of resources (e.g., money). In some embodiments, the plan may be based on an inflow or receipt of resources (e.g., income). In some embodiments, one or both of the outflow and inflow may be measured over one or more periods of time or in response to the occurrence of one or more events.

In some embodiments, the user may be incentivized to participate in the plan. For example, in some embodiments, the user may be provided with a matching contribution. The matching contribution may be received from one or more entities, such as a sponsor or provider of the plan. In some embodiments, the user's participation in the plan may result in the user being entered into a “lottery,” such as a “savings lottery.”

Other aspects and features of this disclosure will be described below.

### BRIEF DESCRIPTION OF THE DRAWINGS

Various embodiments are illustrated by way of example in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of one or more aspects of the present disclosure.

FIG. 3 is an example flow diagram of steps performed by one or more devices in accordance with one or more aspects of the disclosure.

### DETAILED DESCRIPTION

Users may find it challenging to determine how much they need to save. For example, a user may struggle to determine how much of her paycheck to allocate to savings, investments, checking, bill pay, discretionary spending, etc. Therefore, the example embodiments of this disclosure provide for the establishment of an automated plan tailored to a particular user's needs, behaviors, and patterns. The plan may be subject to modification based on manual input. The plan may be adapted in response to one or more inputs, conditions, or events.

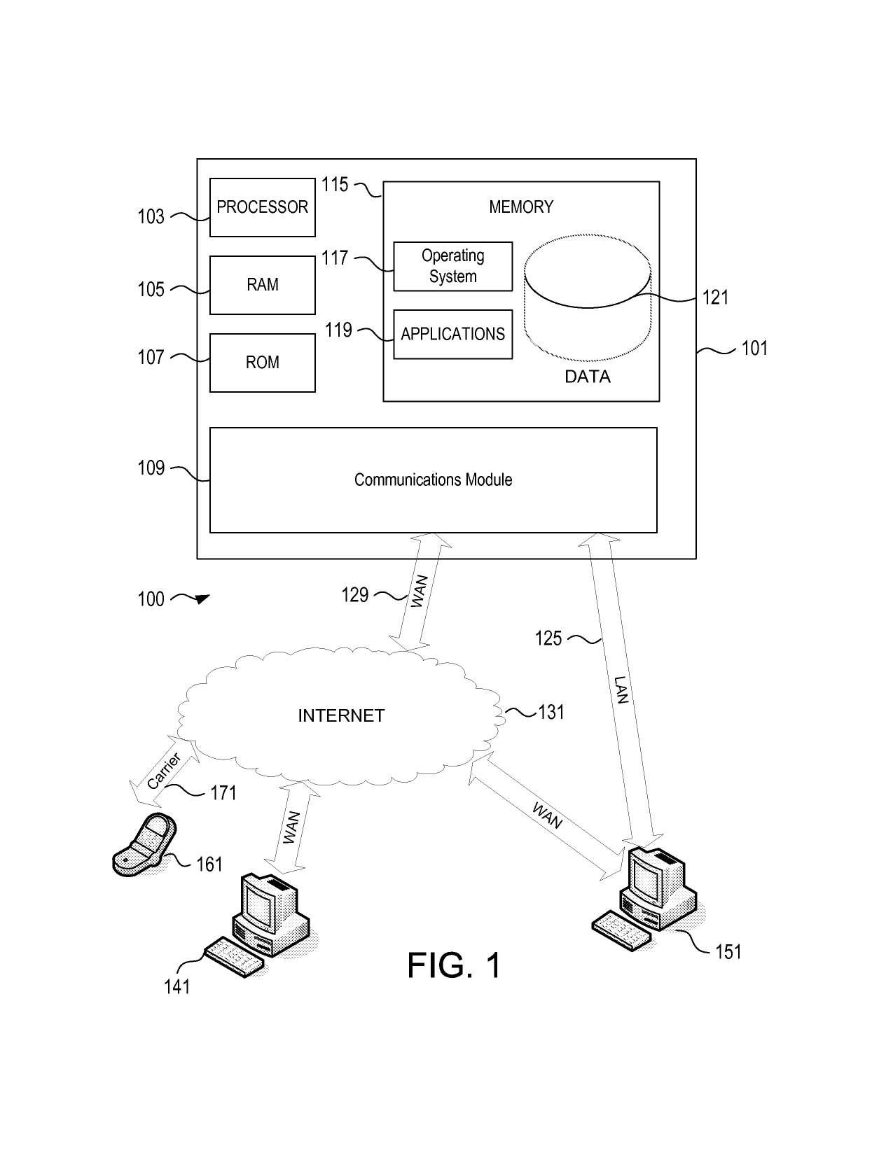

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Processor 103 and its associated components may allow the computing device 101 to run a series of computer-readable instructions related to analyzing customer data to determine if a reward is appropriate. Processor 103 may also direct computing device 101 to transmit a predetermined reward to an individual, group, and/or organization based on this analysis.

Computing device 101 typically includes a variety of computer readable media. Computer readable media may be any available media that may be accessed by computing device 101 and include both volatile and nonvolatile media, removable and non-removable media. By way of example, and not limitation, computer-readable media may comprise a combination of computer storage media and communication media. Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown).

Exemplary usages include scanning and converting paper documents, e.g., correspondence, receipts, etc. to digital files.

Although not shown, RAM 105 may include one or more applications representing the application data stored in RAM 105 while the computing device 101 is on and corresponding software applications (e.g., software tasks) are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 125 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications (e.g., for transmitting reward information, monitoring relationship levels, sending information to potential customers/customers about products/services offered by an entity, etc.). In addition, the application programs 119 may include computer executable instructions for invoking one or more of functions described herein.

Embodiments of the disclosure may include forms of computer-readable media.

Computer-readable media include any available media that can be accessed by computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium may store instructions that, when executed by one or more processors, cause an apparatus or system to perform steps of a method in accordance with aspects of the disclosed embodiments. For example, aspects of the method steps disclosed herein may be executed on a processor 103 on computing device 101. Such a processor may execute computer-executable instructions stored on a computer-readable medium.

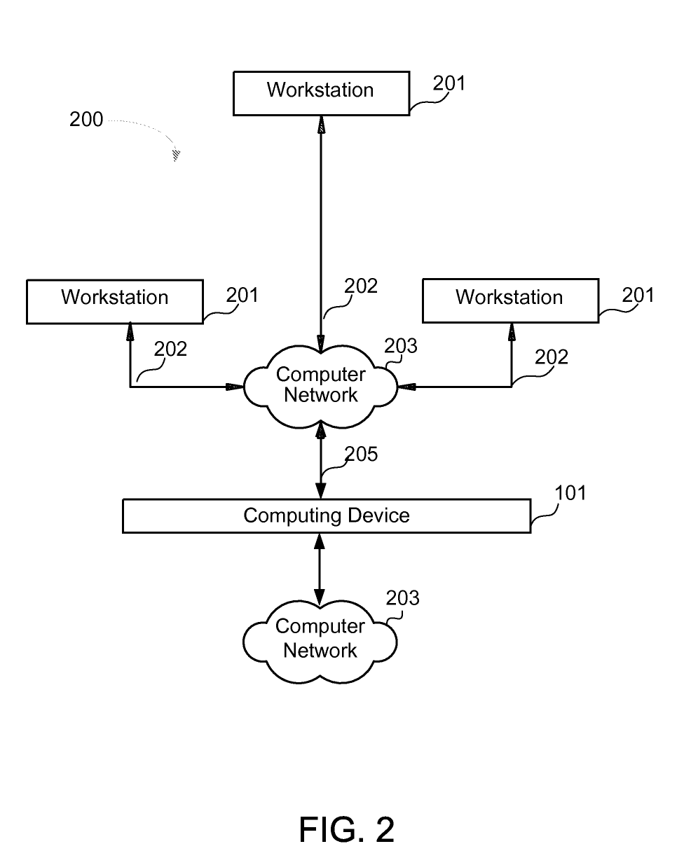

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to a computer network 203 that is linked via communications links 205 to computing device 101. Workstations 201 may include many of the same hardware/software components as computing device 101. In some embodiments, workstations 201 may represent data stores for storing customer data accessed and used by computing device 101. In other embodiments, workstations 201 may represent various user terminals for accessing computing device 101. In system 200, computing device 101 may be any suitable server, processor, computer, or data processing device, or combination of the same. Computing device 101 may be used to process the instructions received from, and the transactions entered into by, one or more participants.

Computer network(s) 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and computing device 101, such as network links, dial-up links, wireless links, hard-wired links, etc.

The steps that follow in the Figures may be implemented by one or more of the components in FIGS. 1 and 2 and/or other components, including other computing devices.

In accordance with various aspects of the disclosure, methods, computer-readable media, systems, and apparatuses are disclosed that allow an entity, such as a company, an organization, a bank, a credit union, a government agency, a university, an individual, group, etc., to implement methodologies for maintaining and/or developing a plan for a user. In some embodiments, the user may be a customer of the entity or share some other relationship with the entity. In some embodiments, the user may be a person, a family, or another entity.

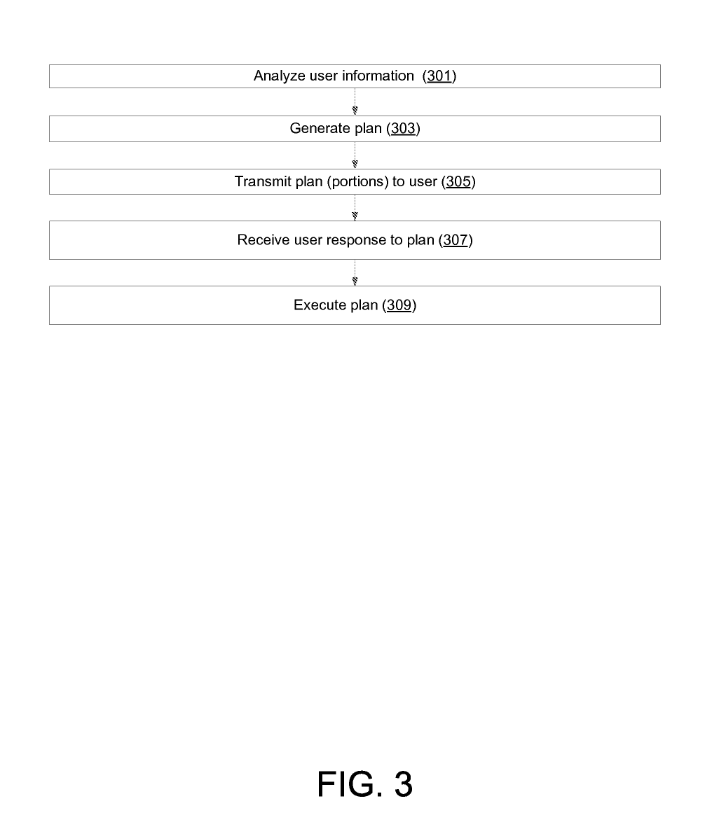

FIG. 3 illustrates a method that may be used to establish and maintain a plan for a user.

In some embodiments, the plan may be related to the user's finances. For example, the plan may include various components or elements related to savings, investments, checking, bill pay, discretionary spending, etc. The method of FIG. 3 may execute on one or more devices, such as computing device 101 and/or workstation 201, for example.

In step 301, user information may be analyzed. The user information may relate to an outflow or expenditure of resources by the user. For example, the outflow may be based on money spent by the user in the form of a mortgage payment, insurance payments, tax payments, medical bills, tuition bills, etc. The user information may relate to an inflow of resources. For example, the inflow may be based on a paycheck received by the user, a gift received by the user, tax refund received, etc. In some embodiments, a combination of the inflow and outflow may be taken into consideration to determine the net inflow. For example, the total outflow may be subtracted from the total inflow to determine the net inflow. In some embodiments, a user's account (e.g., a user's bank account) may be analyzed in connection with step 301 to determine values for inflow and/or outflow.

The analysis of step 301 may occur periodically. For example, the analysis of step 301 may occur daily, weekly, monthly, or based on some other schedule or frequency. Also, in some embodiments, the analysis of step 301 may be triggered in response to an occurrence of one or more events or conditions. For example, if the user receives a job promotion or is hired, is fired or laid off, is hospitalized, withdraws a relative large amount of money (e.g., withdraws an amount of money that exceeds a threshold), has a child that is born or dies, etc., then the analysis of step 301 may be triggered.

In step 303, a plan may be generated based on the analysis of step 301. As part of step 303, a determination may be made whether a pre-existing plan exists for the user. If it is determined that a plan had not previously been established for the user, a plan may be created for the user in connection with step 303. On the other hand, if a pre-existing plan exists for the user, the plan may be updated or modified, or replaced with a new plan, based on the results of the analysis conducted in connection with step 301.

The plan generated in connection with step 303 may provide recommendations to the user regarding the user's finances. The analysis and generated plan of steps 301 and 303 may be based on any number of input factors and conditions. For example, the user's attributes (e.g., age, sex, medical history, family history, identification of dependents/children, financial history, etc.) may be taken into consideration in formulating the plan. For example, an older user (e.g., a user above a threshold age, such as age sixty-five) with minimal savings may be targeted for a more aggressive savings plan involving less risky assets. Also, a younger user (e.g., a user below a threshold age, such as age 21) with established savings may be targeted for a more aggressive investment plan involving risky assets. Similarly, if the user has children or dependents, a degree or allocation of savings may be a function of the number children or dependents. For example, each child or dependent may result in an additional D% being allocated to savings. In some embodiments, the rate of increase or decrease in terms of savings need not be a linear function. For example, the rate of increase or decrease may adhere to any formula or function in various embodiments. The user's sex may determine, e.g., how the user's resources are allocated—for example, a greater allocation to savings may be made for males relative to females. A person with a history of medical disease in his/her family (e.g., taking into account a person's genomic data) may similarly have a plan generated that allocates a greater degree of resources to savings relative to a similarly situated person that does not have such disease in his/her family history. A person that has a history of paying his/her bills on time may have a plan generated that allocates less to savings relative to a similarly situated person that has a record of making late bill payments.

In step 305, a portion, or all, of the plan generated in step 303 may be transmitted to the user. For example, if the user did not have a pre-existing plan, the user may be presented with the entirety of the plan in connection with step 305. On the other hand, if the user had a pre-existing plan, the user may be presented with the modifications or recommended updates to the plan in connection with step 305.

In step 307, a response from the user may be received in regards to the plan. For example, the user may accept the plan or reject the plan. The user may accept a portion of the plan and may reject the rest of the plan. The user may request that one or values or conditions of the plan be modified. For example, if the generated and presented plan of steps 303 and 305 recommend that W% of the user's paychecks be allocated to savings and X% of the user's paychecks be allocated to discretionary spending, the user may request that Y% of the paychecks instead be allocated to savings (where W, X, and Y are numerical values, and where W and Y are different numerical values).

In response to a request by the user to either reject a portion of the generated plan or modify a value or condition associated with the generated plan, the plan provider or sponsor may determine whether the user's request is acceptable. If the user's request is acceptable to the plan provider or sponsor, the user's request may be implemented in the plan.

If the user's request is not acceptable to the plan provider or sponsor, then any number of actions may be taken in response thereto. For example, only those portions of the plan that were accepted by the user may be implemented. Other terms or conditions associated with the plan may be modified in response to the user's request, and the user may be presented with an alternative plan. As an example of presenting the user with an alternative plan, and continuing the above example, if the user's request to allocate Y% of the user's paycheck to savings was not initially acceptable to the plan provider or sponsor, the plan provider/sponsor may modify another term or condition associated with the plan, such as the percentage of the user's paycheck allocated to discretionary spending, in order to accommodate the user's request. An alternative plan, including a Y% allocation to savings and a Z% allocation to discretionary spending (where Z is a numerical value different from the initial value X for the discretionary spending allocation) may be presented to the user. This process may continue repeatedly or more than once, and may be representative of a negotiation between the user and the plan provider or sponsor until the parties arrive at a mutually agreeable plan.

In step 309, one or more portions of the generated plan (subject to any modifications by the parties as described above in connection with step 307) may be executed. For example, the user's paychecks may automatically be allocated to various categories or components of the plan, such as savings, investments, checking, bill pay, discretionary spending, etc. in accordance with the plan.

The method described above in connection with FIG. 3 is illustrative. In some embodiments, one or more steps (or portions thereof) may be executed in an order or sequence different from what is shown in FIG. 3. In some embodiments, additional steps not shown may be included. In some embodiments, one or more steps (or portions thereof) may be optional. For example, a user might not want to be bothered with the details of a plan, or an update to the plan. The user might be provided an option to consent to any plan, or modification thereto, suggested or recommended by the plan provider or sponsor. In this regard, the user might simply receive a confirmatory memo or receipt that her plan was created or updated, such that the user might not be required to affirmatively accept the plan or updates.

In some embodiments, the plan provider or sponsor may provide one or more incentives to the user to participate in the plan. For example, the plan provider or sponsor may provide the user with a matching contribution to incentive the user to allocate resources (e.g., money) to, e.g., savings. The matching contribution may be based on one or more schemes, such as dollar for dollar, as a fraction or percentage of the amount allocated by the user to savings, as a predetermined amount for each transaction or each type of transaction conducted by (or on behalf of) the user, as an amount based on the value of transactions conducted by the user, as a predetermined amount allocated at periodic intervals, as a predetermined amount based on an amount available in an account, etc. In some embodiments, the matching contribution may include a discount or rebate associated with the purchase of one or more products or services.

Continuing with the aforementioned examples of incentives, the user can receive additional bonus or match money to encourage use of the savings program. For example, the bonus or match money may be in the form of interest that would be in addition to the interest the holder would normally earn in an interest-bearing account. For example, at the end of the year, the user's financial institution may match the savings at 100% for the first 3 months and 5% thereafter. The user may continue to receive this 5% match reward of the savings amount each year around the anniversary date. This bonus or match money may be capped, for example, up to a predetermined amount of money (e.g., $250). One skilled in the art will appreciate after review of the entirety disclosed herein that the disclosure contemplates other techniques for matching or providing a bonus. For example, one of numerous variations contemplated by the disclosure includes providing different percentage/amount of interest yield during a particular time period.

In yet another embodiment, the savings amount may be applied against outstanding debt. For example, the savings amount may be used to pay down debt (e.g., mortgage, student loans, credit cards, etc.) as another use of the money saved. Any matching (or bonus) amount may also be applied against outstanding debt. In another embodiment, the recipient account may be a retirement account (e.g., an IRA account, Roth IRA account, etc.).

In one example, the matching (i.e., bonus) paid to the user may be based on one or more factors. For example, a financial institution may offer to match the savings amount by providing $0.05 for every $1 of savings. In another example, the financial institution may offer another predefined amount for every $1 in savings. The matching may be provided for only a predetermined period of time, for example, during the first six months of enrolling in the program. Furthermore, the matching may be a based on a percentage of the savings amount (e.g., 100%—dollar for dollar, 50%—50 cents to the dollar, etc.) A computer system may verify that a user is eligible for matching/bonus before crediting the match amount to the user's account.

In yet another embodiment in accordance with aspects of the disclosure, the matching/bonus amount may be a predetermined amount at a regular interval. For example, a $100 may be automatically transferred from a user's checking account to his/her savings account. The $100 transferred savings amount may be entitled to the same (or more or less, as would be apparent to one skilled in the art after review of the entirety disclosed herein) of a match/bonus as other savings amounts sent into the account. In another embodiment, the matching may require that the total balance on the savings account is growing by more than a particular percentage month after month. In yet another embodiment, the user may be required to maintain a minimum balance in his/her account (e.g., checking and/or savings) to be eligible for matching/bonus. In yet another embodiment, the total amount of matching/bonus for a given period of time (e.g., one year) may be limited to a predefined maximum value.

In another example, the match/bonus may be based on a balance tier system (i.e., the amount of balance in a user's account may categorize them into different tiers with varying matching/bonus levels). An incentive engine executing in a computer system (e.g., using processor) may receive the appropriate balance total from a deposit system. The received balance total may be a pre-calculated value that the computer system may use without further intensive processing. Alternatively, the received balance total may be calculated at computer system in numerous ways in accordance with aspects of the disclosure: a multi-month moving average, monthly average, current balance, average daily balance over the prior 12 months, average daily balance over the last 30 days, balance at the time the matching/bonus amount is calculated (i.e., the balance in the account on the date when the savings occurred), minimum balance during the prior 30 days, average over the last 90 days, etc. The incentive engine may comprise of computer-executable instructions used to determine the match level based on this calculated balance. The incentive engine may access (e.g., in memory) a table with information about match level and the balance total corresponding to that match level. At least one technical benefit of such a system is that it allows the tiers or match levels to be changed with greater flexibility. For example, a user with a balance less than $1,000 may receive a 2% match on their savings amount. Meanwhile, a user with a balance of at least $1,000, but not more than $10,000 may receive a higher match (e.g., 5%) on their savings amount. Moreover, a user with a balance of $10,000 or more may receive an even higher percentage match. One skilled in the art after review of the entirety disclosed herein will appreciate that the matching may be other than a percentage amount. For example, the balance tier may include an approach wherein as the balance increases, the matching is a predetermined amount that also increases with each balance tier.

In another embodiment, a merchant matching feature may be included in accordance with aspects of the disclosure. For example, a list of merchants may be provided to a user that will cause the user to achieve increase matching/bonus levels for his/her savings amount. In one example, the merchants may provide a portion or all of the matching/bonus funds transferred to the user's account for purchases associated with the merchant. As such, the user may be motivated to shop with the merchant. For example the merchant matching feature may provide a user with $1 of savings bonus into the user's savings account for every $100 spent with the merchant.

In another example, the matching (i.e., bonus) paid to the user may be based on the user growing his/her account balance over a period of time (e.g., subsequent number of months). For example, a user may be paid a particular matching/bonus level for the first 3 months, but if the holder increases the balance of his/her savings account for the subsequent six month following the first 3 months, a financial institution may retroactively apply a bonus (e.g., 2% interest, etc.) to the first 3 months balance. One skilled in the art will appreciate after review of the entirety disclosed herein that there are numerous techniques disclosed for calculating balance for a period of time and may be applied to the aforementioned embodiment. In another example, the user may be required to maintain a minimum balance (e.g., $300) and/or enroll in an automatic scheduled transfer (e.g., a monthly automated transfer of $25 from a checking to the savings account) to be eligible for the aforementioned retroactively applied bonus feature. Furthermore, in yet another embodiment, if the savings account balance is the same or higher at the one-year anniversary date of enrolling in the savings program, a financial institution may at least double the matching/bonus amount to help grow the savings amount even more.

As explained throughout the disclosure herein, the matching amount may be deposited in a recipient account with a financial institution. Some examples of recipient accounts include savings accounts that have restrictions on the user's ability to withdraw funds without early withdrawal penalties. In addition, the matching amount may be deposited in various different types of recipient accounts (e.g., gift card account, etc.)

In accordance with various aspects of the disclosure, a matching amount may be paid out at one or more times or regular intervals. For example, a financial institution may pay a bonus at the one-year anniversary of enrolling in the savings program on the balance on the one-year date. As such, a user that withdraws money prior to the one-year date may not achieve maximum matching/bonus. In another example, the matching amount may be paid at the end of each day. In yet another example, a matching amount may be paid in “near realtime” as transactions eligible for matching are received. In yet another example, matching amounts are paid out only after an aggregate match amount threshold (e.g., $10) has been reached. As such, a financial institution can reduce the number of transfers that are required to implement a savings program in accordance with aspects of the disclosure.

In accordance with various aspects of the disclosure, a user may enroll in a commitment contract in which the user may commit to a goal. If the user achieves the goal, the user may receive a reward (e.g., a dollar-for-dollar matching of particular funds, a percentage matching of funds, or other forms of rewards, including those described throughout this disclosure). However, if the user fails to achieve the goal, a punishment may be administered. In one example, a user may commit to contributing X% (e.g., 2%) of their monthly income towards a savings account and receive a dollar-for-dollar matching of the saved amount at the end of a period of time (e.g., a month, a year, etc.) A financial institution may provide the matched funds, or the matched funds may be provided through a different source (e.g., a merchant, a government entity, a group of friends/family, etc.) However, if the user fails to achieve the goal, the user's saved amount may be transferred into a long-term savings product (e.g., a certificate of deposit) with limited or prohibited withdrawal for an extended period of time (i.e., causing the user to save for the long-term). In other embodiments of the example, the user's failure may cause the saved funds to get donated to a preselected charity, donated to an opposing political party's campaign, committed to a pooled fund for those participating in these types of savings programs to help fund the matching, fund a lottery-type program, or other form of transfer. In addition, the disclosure contemplates a goal of the commitment contract being something other than just fiscal. For example, the commitment contract may be for paying oneself to maintain a healthy weight (e.g., losing a pound a week until reaching X total pounds final weight), such that when the goal is reached, X amount of funds are released for use towards a desired purchase (e.g., a new pair of shoes); however, if the goal is not met, X amount of funds may be lost (e.g., transferred to a preselected charity, or one of the other examples provided above). One skilled in the art after review of the entirety disclosed herein will appreciate that implementation of the commitment contract may be through the use of a computing device 101 and computer-executable instructions stored thereon, as well as other computer systems/networks described herein.

As yet another example of an incentive that a plan provider or sponsor may provide a user to participate in a plan, the plan provider or sponsor may enroll a participating user in a “lottery.” In one example, lottery plan participants may be required to save X% of their income (or a predetermined X amount) per week to be eligible for the lottery. The lottery may provide regular payouts (e.g., weekly drawings, monthly drawing, etc.) and the randomly selected winner may be awarded X additional amount (or X additional percentage of their savings amount). Plan participants (e.g., those users that are enrolled in a plan, possibly subject to other terms or conditions) may receive one or more rewards, contributions, or prizes from the plan provider or sponsors. One or more plan participants may receive the reward(s), contribution(s), or prize(s) in connection with the lottery based on a random drawing. The lottery may be a one-time event, may occur periodically, or may be initiated at various points in time to attract additional business to the plan provider or sponsor. In some embodiments, the lottery may occur more than once, but an enrolling user might only be eligible to receive the benefits from a particular lottery or subset of lotteries. At least one benefit of a regular lottery is that it provides more frequent, lower relative cost rewards that reinforce positive behavior than a yearly reward for which some users may lose motivation after time passes. For example, in some instances a user may be messaged (e.g., SMS text message, e-mail message, etc.) that they would have won that week's lottery except for the fact they failed to qualify because they failed to meet the week's goal. Such messaging may reinforce positive behavior and further motivate plan participants.

Aspects of this disclosure may readily be applied to, and adapted to be operative on, one or more communication systems. Those communication systems may include computer networks, television networks, satellite networks, telephone and cellular networks, and the like.

Although not required, various aspects described herein may be embodied as a method, a data processing system, and/or as a transitory and/or non-transitory computer-readable medium storing executable instructions. Accordingly, those aspects may take the form of an entirely hardware embodiment, an entirely software embodiment, an entirely firmware embodiment, or an embodiment combining software, firmware and hardware aspects. The functionality may be resident in a single computing device, or may be distributed across multiple computing devices/platforms, the multiple computing devices/platforms optionally being connected to one another via one or more networks. Moreover, the structural components described herein may be distributed amongst one or more devices, optionally within a common housing or casing.

Various signals representing content, data, information, or events as described herein may be transferred between a source and a destination in the form of electromagnetic waves traveling through signal-conducting media such as metal wires, optical fibers, and/or wireless transmission media (e.g., air and/or space).

The various methods and acts may be operative across one or more computing servers, databases, and one or more networks. The functionality may be distributed in any manner, or may be located in a single computing device (e.g., a server, a database, a client computer, etc.). As discussed herein, data (e.g., plans, incentives, rewards, prizes, contributions, etc.) may be distributed to intermediary/network components and client-side devices at various times and in various formats. The distribution and transmission techniques described herein may leverage existing components and infrastructure to minimize power dissipation, operational complexity, footprint size, and management involvement, amongst other factors and costs.

The methodological acts and processes described herein may be tied to particular machines or apparatuses. For example, one or more product or service offerings, such as a plan, may be transmitted to a user device or location via one or more computing devices (e.g., servers) and the offer(s) may be displayed at the user location via one or more terminals and/or display devices. One or more acceptances, rejections, and/or counter offers may be transmitted from a user device or location to one or more computing devices (e.g., servers). In some embodiments, (additional or supplemental) information regarding a user, such as a user's financial or transaction history, or attributes associated with the user, may be transmitted from a user device or other location to one or more computing devices (e.g., servers). More generally, one or more computers may include one or more processors and memory storing instructions that, when executed, perform the methodological acts and processes described herein. Furthermore, the methodological acts and processes described herein may perform a variety of functions including transforming an article (e.g., disorganized information regarding a user) into a different state or thing (e.g., an agreed to plan that automatically allocates the user's resources in accordance therewith).

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

1. An apparatus configured to provision a savings plan for a user, the apparatus comprising:
at least one processor; and
memory storing instructions that, when executed by the at least one processor, cause the apparatus to:
analyze information associated with the user, wherein the information associated with the user comprises at least an outflow of money spent by the user and an inflow of resources associated with the user;
generate a plan based at least in part on the analyzed information, wherein the plan comprises a savings component, and wherein the savings component is determined based at least in part on the outflow of money spent by the user and the inflow of resources associated with the user; and
execute at least a portion of the plan,
wherein the execute at least a portion comprises the savings component.

2. The apparatus of claim 1, wherein the information associated with the user comprises at least one of an age of the user, a sex of the user, a medical history of the user, a family history of the user, an identification of a dependent or child of the user, and a financial history of the user.

3. The apparatus of claim 1, wherein the information associated with the user comprises an age of the user, and wherein when the age of the user is above a threshold value, the generated plan allocates a greater portion of an income of the user to the savings component relative to when the age of the user is below the threshold value.

4. The apparatus of claim 1, wherein the plan comprises investment, checking, bill pay, and discretionary spending components, and wherein the executed at least a portion comprises at least one of the investment, checking, bill pay, and discretionary spending components.

5. The apparatus of claim 1, wherein the instructions, when executed by the at least one processor, further cause the apparatus to:
transmit the at least a portion of the plan to a device associated with the user.

6. The apparatus of claim 5, wherein the instructions, when executed by the at least one processor, further cause the apparatus to:
receive a response based on the at least a portion of the plan from the device.

7. The apparatus of claim 6, wherein the response comprises at least a partial acceptance of the at least a portion of the plan.

8. The apparatus of claim 6, wherein the response comprises a request to modify at least one of a value and a condition associated with the at least a portion of the plan, and wherein the instructions, when executed by the at least one processor, further cause the apparatus to:
transmit a revised plan to the device,
wherein the revised plan comprises at least one of a modified value and a modified condition relative to at least one of a value and a condition included in the at least a portion of the plan.

9. The apparatus of claim 1, wherein the instructions, when executed by the at least one processor, further cause the apparatus to:
transmit an offer to a device associated with the user,
wherein the offer comprises an incentive for the user to participate in the plan.

10. The apparatus of claim 9, wherein the incentive comprises a matching contribution associated with the savings component.

11. The apparatus of claim 9, wherein the incentive comprises enrollment in a lottery.

12. A method comprising:
analyzing, at a computerized apparatus including a processor, information associated with a user, wherein the information associated with the user comprises at least an outflow of money spent by the user and an inflow of resources associated with the user;
generating, at the apparatus, a plan based at least in part on the analyzed information, wherein the plan comprises a savings component, and wherein the savings component is determined based at least in part on the outflow of money spent by the user and the inflow of resources associated with the user; and
executing at least a portion of the plan,
wherein the executed at least a portion comprises the savings component.

13. The method of claim 12, wherein the information comprises an age of the user, a sex of the user, a medical history of the user, a family history of the user, an identification of a dependent or child of the user, and a financial history of the user.

14. The method of claim 12, further comprising:
transmitting the plan to a device associated with the user; and
receiving a response from the device, wherein the response comprises an acceptance of the at least a portion of the plan,
wherein the executing of the at least a portion of the plan is responsive to receiving the response from the device.

15. The method of claim 14, wherein the response further comprises a request to modify a value included in a second portion of the plan, the method further comprising:
transmitting a revised plan to the device, wherein the revised plan comprises the modified value and a modification to a second value included in the plan;
receiving a second response from the device, wherein the second response comprises an acceptance of the modified value and the modification to the second value; and
executing the second portion of the plan responsive to receiving the second response.

16. The method of claim 12, further comprising:
transmitting an offer to a device associated with the user,
wherein the offer comprises an incentive for the user to participate in the plan.

17. The method of claim 16, wherein the incentive comprises a contribution, wherein the contribution comprises at least one of: dollar for dollar matching, matching as a fraction or percentage of an amount allocated by the user to savings, matching a predetermined amount for each transaction or each type of transaction conducted by or on behalf of the user, matching an amount based on a value of transactions conducted by the user, matching a predetermined amount at periodic intervals, matching a predetermined amount based on an amount available in an account, and providing at least one of a discount and a rebate associated with the purchase of at least one of a product and a service.

18. The method of claim 16, wherein the incentive comprises enrollment in a lottery, and wherein the lottery is conducted periodically.

19. A non-transitory computer-readable medium comprising instructions that, when executed, cause one or more apparatuses to:
analyze information associated with a user, wherein the information associated with the user comprises at least an outflow of money spent by the user and an inflow of resources associated with the user;
generate a plan for the user based on the analyzed information, wherein the plan comprises at least two values, wherein the plan comprises a savings component, and wherein the savings component is determined based at least in part on the outflow of money spent by the user and the inflow of resources associated with the user;
transmit the plan and at least one incentive for participating in the plan to a device associated with the user;
receive a response from the device, wherein the response comprises a modified value for a first of the at least two values;
generate a second plan in response to the received response, wherein the second plan comprises the modified value for the first of the at least two values and a modified value for a second of the at least two values;
transmit the second plan to the device;
receive a second response from the device; and
execute the second plan.

20. The non-transitory computer-readable medium of claim 19, wherein the instructions, when executed, cause the one or more apparatuses to:
determine a net inflow of resources associated with the user,
wherein the generated plan is based on the determined net inflow of resources.
